(19) United States
(12) Patent Application Publication
(10) Pub. No.: US 2013/0091841 A1
(43) Pub. Date: Apr. 18, 2013

(54) MULTI CYCLE GEOTHERMAL POWER PLANT

(71) Applicants: Celine Mahieux, Baden (CH); Christophe Doublet, Baden (CH); Markus Fluck, Koblenz (CH); François André Girard, Neuilly sur Seine (FR); Michael Hiegemann, Rufenach (CH)

(72) Inventors: Celine Mahieux, Baden (CH); Christophe Doublet, Baden (CH); Markus Fluck, Koblenz (CH); François André Girard, Neuilly sur Seine (FR); Michael Hiegemann, Rufenach (CH)

(21) Appl. No.: 13/551,771

(22) Filed: Jul. 18, 2012

Related U.S. Application Data
(63) Continuation of application No. PCT/EP2011/050198, filed on Jan. 10, 2011.

(30) Foreign Application Priority Data
Jan. 19, 2010 (IT) MI2010A000047

(51) Int. Cl. F03G 7/04

(52) U.S. Cl. CPC F03G 7/04
USPC 60/641.2

(57) ABSTRACT

A multi cycle geothermal power plant (5) has at least the following cycles: a primary cycle (10) configured for a geothermal reservoir fluid; a closed loop second cycle (20) having a vaporizer (7), spanning the primary cycle (10) and second cycle (20), for transferring thermal energy from the primary cycle (10) to the second cycle (20); and at least one further closed loop water/steam cycle (30) having a heat exchanger (8), spanning the primary cycle (10) and each further cycle (30), for transferring thermal energy from the primary cycle (10) to each further cycle (30). By providing indirect secondary cycles, the power plant (5) is capable of exploiting high impurity wells with high energy extraction efficiency.

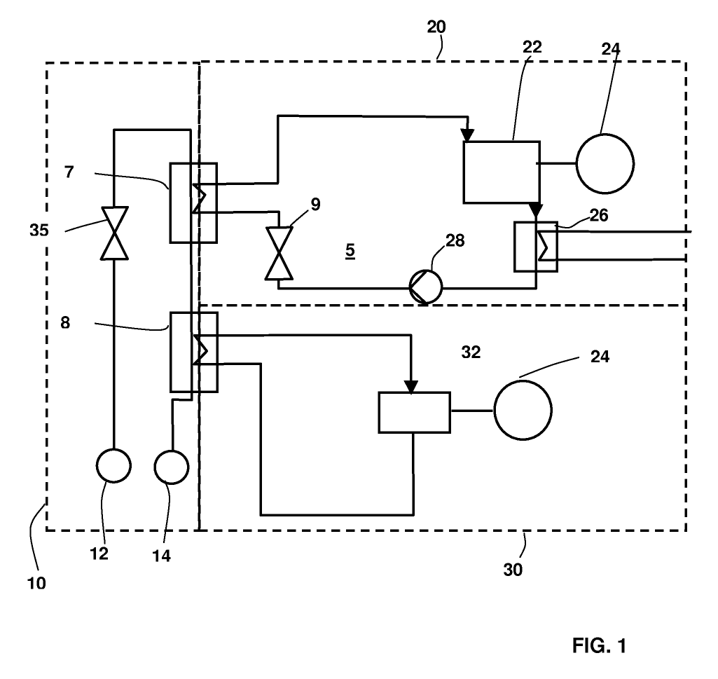

This application is a Continuation of, and claims priority under 35 U.S.C. §120 to, International App. No. PCT/EP2011/050198, filed 10 Jan. 2011, and claims priority therethrough under 35 U.S.C. §§119, 365 to Italian App. No. MI2010A000047, filed 19 Jan. 2010, the entireties of which are incorporated by reference herein.

### BACKGROUND

1. Field of Endeavor

The disclosure relates generally to geothermal power plants and specifically to geothermal power plant configurations suitable for higher temperature reservoirs that have reservoir fluid temperatures significantly above 100° C.

2. Brief Description of the Related Art

Common geothermal plant configurations incorporating turbines include direct cycles, indirect cycles or hybrid cycles with both indirect and direct cycles,

Indirect cycles include multi-cycle configurations having a primary cycle, in which reservoir fluid flows through, and a second cycle, having a closed loop circulating fluid that includes a turbine for extracting energy from the circulating fluid. Such cycles may be configured as organic Rankine cycles (ORC) or Kalina cycles. Multi-cycle configurations are typically used in low temperature geothermal reservoirs as the additional capital cost of having at least two cycles is offset by the ability to extract energy from relatively low temperature sources.

While some of the early higher temperature geothermal reservoirs used binary steam cycles, due in part to impurities in geothermal fluids, improvements in technology, particularly in steam turbine technology, has resulted in the predominance of direct cycles, utilizing dry steam or single and multi-flash configurations, in high reservoir temperature applications. Despite these technical advances, impurities in geothermal reservoir fluids still present challenges. For example, there may be a need for additional H₂S and Hg removal equipment. Corrosion may also be a problem, especially in mineral rich reservoirs. This problem is commonly overcome by the use of more expensive corrosion resistant steel alloys, titanium alloys, or coatings, adding significant cost to the more complex mechanical units such as the turbine. In addition, silica, a particular problem in flash drums, in high concentration is slightly soluble in flash or dry steam and so can further lead to turbine fouling.

Coupled to the fact that no two geothermal reservoirs are the same and that the impurity levels of a particular reservoir may change with time, it may take several years of operation and testing to fully understand a given reservoir's conditions in order to optimize, in particular, the steam turbine in order to overcome the problems caused by impurities. As such time is rarely available, the steam turbine is typically over-engineered, resulting in both reduced efficiency and increased cost.

Further impacting cost and efficiency is the comparably low temperature and high wetness a steam turbine, typically used in direct cycles, is required to operate in. To overcome the problems caused by these factors typically requires over-sizing and over-designing the turbine.

### SUMMARY

A geothermal power plant is provided that is suitable for operation in higher temperature reservoirs, typically the domain of direct cycle systems, while providing high efficiency and improved resilience to impurities thus enabling standardization of design of major equipment items such as the turbine unit(s).

An embodiment is based on the general idea of providing a second close loop steam/water cycle and a further closed loop cycle for extracting heat from a reservoir fluid. Such a power plant is suitable for reservoirs that have a high enough temperature to generate steam of sufficient pressure and temperature to operate a steam turbine. By configuring the second and further cycles, as a closed loop cycle, the cycle fluid remains free of reservoir contaminates, enabling standardization of design and, in particular, enable the second loop to be cost effectively configured as a steam/water loop. This is further added by the further closed loop cycle that is capable of removing low-grade heat from the reservoir, thus improving the economics of the power plant. In addition by having only closed loop second and further cycles, essentially all reservoir fluid extracted from the reservoir may be returned to the reservoir, increasing the potential life of the reservoir.

An aspect provides a multi cycle geothermal power plant that comprises a primary cycle, a closed loop second cycle and at least one further cycle. The primary cycle is configured for a geothermal reservoir fluid wherein reservoir flows once through the cycle. The second cycle is a closed loop water/steam cycle that has a vaporizer that spans the primary cycle and second cycle for transferring thermal energy from the primary cycle to the second cycle, while the further closed loop cycle has a heat exchanger spanning the primary cycle and the further cycle for transferring thermal energy from the primary cycle to the further second cycle.

Other aspects and advantages of the present invention will become apparent from the following description, taken in connection with the accompanying drawings wherein by way of illustration and example, an embodiment of the invention is disclosed.

### BRIEF DESCRIPTION OF THE DRAWINGS

By way of example, an embodiment of the present disclosure is described more fully hereinafter with reference to the accompanying drawings, in which the single drawing FIGURE illustrates a flowsheet of a geothermal power plant according to a preferred embodiment of the disclosure.

### DETAILED DESCRIPTION OF EXEMPLARY EMBODIMENTS

In the following description, for purposes of explanation, numerous specific details are set forth to provide a thorough understanding of exemplary embodiments. It will be evident, however, that embodiments may be practiced without these specific details.

The drawings FIGURE shows an exemplary embodiment of a multi-cycle geothermal power plant 5. The multi-cycle characteristic of the power plant 5 is provided by the fact that the power plant 5 includes a primary cycle 10 and a secondary cycle.

The primary cycle 10 includes a loop for circulating reservoir fluid therethrough. The reservoir fluid, typically brine, is extracted from a production well 12 and circulates once through the primary cycle 10 before being returned to an injection well 14. Thermal energy is extracted from the reservoir fluid circulating through the primary cycle 10 by one or more heat exchangers 8. In an exemplary embodiment, heat exchangers 8 include vaporizers 7. Filtration devices, not shown, are typically included in the primary cycle 10 to reduce fouling of the equipment within this primary cycle 10.

In an exemplary embodiment, shown in the FIGURE, the secondary cycle has a closed loop second cycle 20 and a closed loop further cycle 30, wherein a closed loop cycle is defined as a loop where the heat transfer fluid flows around a continuous loop with minimal makeup or losses.

In an exemplary embodiment, the second cycle 20 shown in the FIGURE is configured for water/steam heat transfer fluid by the selection of suitable components. A vaporizer 7, in the second cycle 20, spans both the primary cycle 10 and the second cycle 20, i.e., is partially located in both cycles. The purpose of the vaporizer 7 and heat exchanger 8 is to transfer thermal energy from the reservoir fluid circulating through the primary cycle 10 to the water/steam circulating in the second cycle 20 without the contact or mixing of either fluid with each other. In this way, the water/steam of the second cycle 20 remains free of impurities from the reservoir fluid and so the second cycle 20 can be designed for a clean system. The function of the vaporizer 7 is therefore to utilize the thermal energy of the reservoir fluid by vaporizing the water heat transfer fluid of the second cycle 20.

In order to utilize lower temperature thermal energy, an embodiment of the power plant 5 includes a further closed loop cycle that has a heat exchanger 8 for transferring energy from the primary cycle 10 into the further cycle 30. The further cycle 30 typically includes a heat energy extraction unit 32, for example a turbine, coupled to a generator 24 for generating power. In an exemplary embodiment, the further cycle 30 is configured as an Organic Rankine cycle. In another exemplary embodiment, the further cycle 30 is configured as a Kalina Cycle. In an exemplary embodiment, the power plant 5 is configured with more than one further cycles 30.

The purpose of an embodiment of the further cycle 30 is to extract low grade heat from the reservoir fluid after an initial, first, or previous extraction of higher grade heat by the second cycle 20. This is achieved, in an exemplary embodiment, by locating the vaporizer 7 of the second cycle 20 upstream and in series with a heat exchanger 8 of the further cycle 30.

By configuring and exemplary embodiment with a second cycle 20 and at least one further cycle 30, each as closed loop cycles, a high reservoir return rate can be achieved, providing the benefit of increased reservoir life and energy extraction.

Although the disclosure has been herein shown and described in what is conceived to be the most practical exemplary embodiment the present invention may be embodied in other specific forms. The presently disclosed embodiments are therefore considered in all respects to be illustrative and not restricted. The scope of the invention is indicated by the appended claims rather that the foregoing description and all changes that come within the meaning and range and equivalences thereof are intended to be embraced therein.

### REFERENCE NUMBERS

5 Geothermal power plant

7 Vaporiser

8 Heat exchanger

10 Primary cycle

12 Production well

14 Injection well

20 Second cycle

22 Steam turbine unit

24 Generator

26 Condenser

27 Feed pump

30 Third cycle

32 Energy extraction unit

We claim:

1. A multi cycle geothermal power plant comprising:
a primary cycle configured for a geothermal reservoir fluid;
a closed loop second cycle having a vaporizer spanning the primary cycle and the closed loop second cycle, configured and arranged to transfer thermal energy from the primary cycle to the closed loop second cycle; and
at least one further closed loop cycle having a heat exchanger spanning the primary cycle and each at least one further closed loop cycle, configured and arranged to transfer thermal energy from the primary cycle to each at least one further closed loop cycle;
wherein the closed loop second cycle comprises a water/steam cycle.

2. The power plant according to claim 1, wherein each at least one further closed loop cycle is configured as an Organic Rankine Cycle or a Kalina Cycle.

3. The power plant according to claim 1, wherein the closed loop second cycle comprises a steam turbine unit configured and arranged to receive steam from the vaporizer.

4. The power plant according to claim 3, wherein the vaporizer is arranged in series in the primary cycle with the heat exchanger.
